(19) United States
(12) Patent Application Publication
(10) Pub. No.: US 2010/0085863 A1
(43) Pub. Date: Apr. 8, 2010

(54) RETUNING OF FERROELECTRIC MEDIA BUILT-IN-BIAS

(75) Inventors: Nathan Franklin, San Mateo, CA (US); Quan A. Tran, Fremont, CA (US); Qing Ma, San Jose, CA (US)

Correspondence Address: FLIESLER MEYER LLP, 650 CALIFORNIA STREET, 14TH FLOOR, SAN FRANCISCO, CA, 94108, US

(73) Assignee: NANOCHIP, INC., Fremont, CA (US)

(21) Appl. No.: 12/260,045

(22) Filed: Oct. 28, 2008

Related U.S. Application Data
(60) Provisional application No. 61/103,525, filed on Oct. 7, 2008.

(51) Int. Cl. G11B 9/00

(52) U.S. Cl. 369/126; G9B/9

(57) ABSTRACT

Provided herein are embodiments for adjusting a built-in bias of a media including a conductive layer and a ferroelectric layer above the conductive layer. In certain embodiments, a voltage signal is applied between the conductive layer of the media and an electrode (provided over at least a portion of the ferroelectric layer) to thereby tune the built-in bias so that the built-in bias moves in a direction of (i.e., towards) the desired built-in bias. In other embodiments, the temperature of the at least a portion of the ferroelectric layer of the media is elevated to thereby tune the built-in bias so that the built-in bias moves in a direction of (i.e., towards) the desired built-in bias. The desired built-in bias can be a zero built-in bias, or a non-zero built-in bias.

This application claims priority under 35 U.S.C. 119(e) to U.S. Provisional Patent Application No. 61/103,525, filed Oct. 7, 2008, which is incorporated herein by reference.

### BACKGROUND

Software developers continue to develop steadily more data intensive products, such as ever-more sophisticated, and graphic intensive applications and operating systems. As a result, higher capacity memory, both volatile and non-volatile, has been in persistent demand. Also adding to this demand is the need for capacity for storing data and media files, and the confluence of personal computing and consumer electronics in the form of portable media players (PMPs), personal digital assistants (PDAs), sophisticated mobile phones, and laptop computers, which has placed a premium on compactness and reliability.

Nearly every personal computer and server in use today contains one or more hard disk drives (HDD) for permanently storing frequently accessed data. Every mainframe and supercomputer is connected to hundreds of HDDs. Consumer electronic goods ranging from camcorders to digital data recorders use HDDs. While HDDs store large amounts of data, they consume a great deal of power, require long access times, and require “spin-up” time on power-up. Further, HDD technology based on magnetic recording technology is approaching a physical limitation due to super paramagnetic phenomenon. Data storage devices based on scanning probe microscopy (SPM) techniques have been studied as future ultra-high density (>1Tbit/in²) systems. Ferroelectric thin films have been proposed as promising recording media by controlling the spontaneous polarization directions corresponding to the data bits. For example, it has been shown that ferroelectric media that includes a ferroelectric recording layer can be used in a memory device. However, it has been recognized that maintaining stability of the spontaneous polarization of such ferroelectric media may be problematic, potentially limiting use of ferroelectric media in memory devices. It is believed that a built-in bias affects the stability of such media, in that a large built-in bias may result instability. Accordingly, for this, and various other reasons, it would be useful to controllably modify the built-in bias of media including a ferroelectric recording layer.

### BRIEF DESCRIPTION OF THE DRAWINGS

Further details of the present invention are described with the help of the attached drawings in which:

FIG. 1A is a perspective representation of a crystal of a ferroelectric material having a polarization.

FIG. 1B is a side representation of the crystal of FIG. 1A.

FIG. 2A is a cross-sectional side view of an exemplary information storage system including a plurality of tips extending from corresponding cantilevers toward a media.

FIG. 2B is a side view of a tip of the system of FIG. 2A arranged over a domain of a ferroelectric recording layer.

FIG. 3A is an exemplary hysteresis loop graph for a media having a negative built-in bias.

FIG. 3B is an exemplary switched charge versus voltage graph for a media having a negative built-in bias.

FIG. 3C is an exemplary capacitance versus voltage graph for a media having a negative built-in bias.

FIG. 4 is a high level flow diagram that is used to summarize voltage retuning methods for adjusting the built-in bias of media by applying a voltage signal to the media, in accordance with embodiments of the present invention.

FIGS. 5A and 5B illustrate exemplary voltage signals that can be used in the methods described with reference to the flow diagram of FIG. 4.

FIG. 6 is a plot that shows how the built-in bias was adjusted by voltage retuning using a voltage signal similar to the one shown in FIG. 5A.

FIG. 7A is a high level flow diagram that is used to summarize thermal retuning methods for adjusting the built-in bias of media by elevating the temperature of the media to a temperature below the ferroelectric Curie temperature of the ferroelectric layer of the media, in accordance with further embodiments of the present invention.

FIG. 7B is a high level flow diagram that is used to summarize thermal retuning methods for adjusting the built-in bias of media by elevating the temperature of the media to a temperature above the ferroelectric Curie temperature of the ferroelectric layer of the media, in accordance with alternative embodiments of the present invention.

### DETAILED DESCRIPTION

Common reference numerals are used throughout the drawings and detailed description to indicate like elements; therefore, reference numerals used in a drawing may or may not be referenced in the detailed description specific to such drawing if the associated element is described elsewhere.

Ferroelectrics are members of a group of dielectrics that exhibit spontaneous polarization—i.e., polarization in the absence of an electric field. Permanent electric dipoles can exist in ferroelectric materials. Common ferroelectric materials include lead zirconate titanate (Pb[ZrₓTi₁₋ₓ]O₃0<X<1, also referred to herein as PZT). Taken as an example, PZT is a ceramic perovskite material that has a spontaneous polarization which can be reversed in the presence of an electric field.

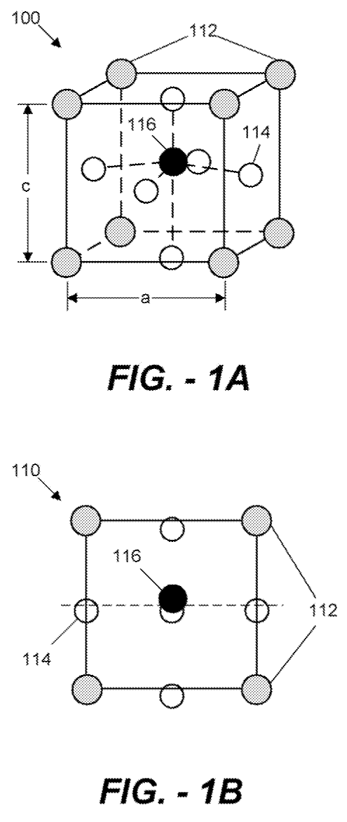

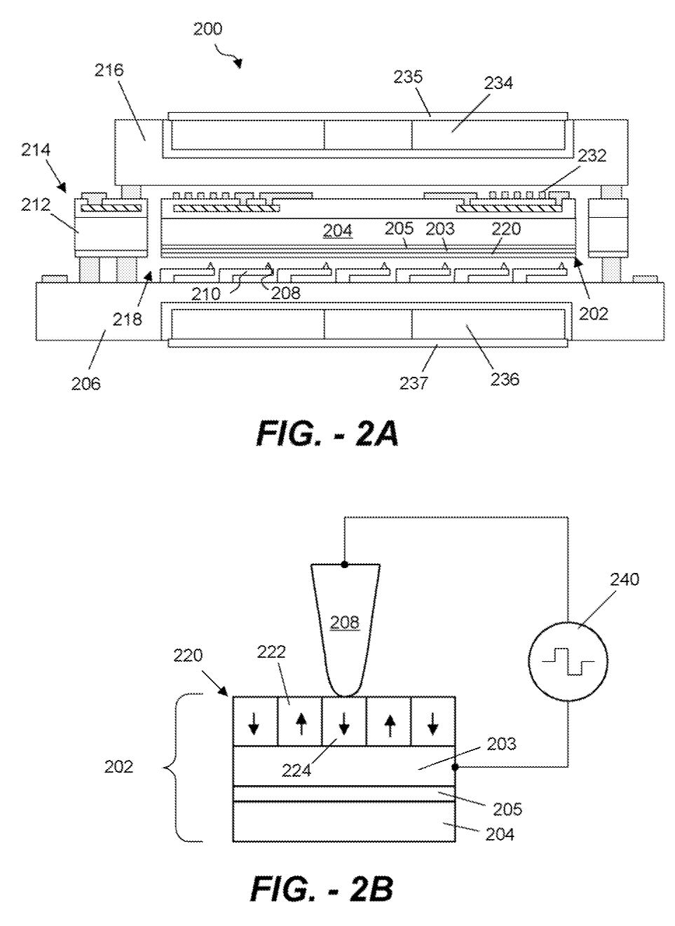

Referring to FIGS. 1A and 1B, a crystal of PZT is shown. Spontaneous polarization is a consequence of the positioning of the Pb²⁺, Zr⁴⁺/Ti⁴⁺, and O²⁻ ions within the unit cell 110. The Pb²⁺ ions 112 are located at the corners of the unit cell 110, which is of tetragonal symmetry (a cube that has been elongated slightly in one direction). A permanent ionic dipole moment results from the relative displacements of the O²⁻ ions 114 and the Zr⁴⁺/Ti⁴⁺ ion 116 from their symmetrical positions. The crystal shown has a dipole moment resulting from O²⁻ ions 114 located near, but slightly below, the centers of each of the six faces, and a Ti⁴⁺ (or Zr⁴⁺) ion 116 displaced upward from the center of the unit cell 110.

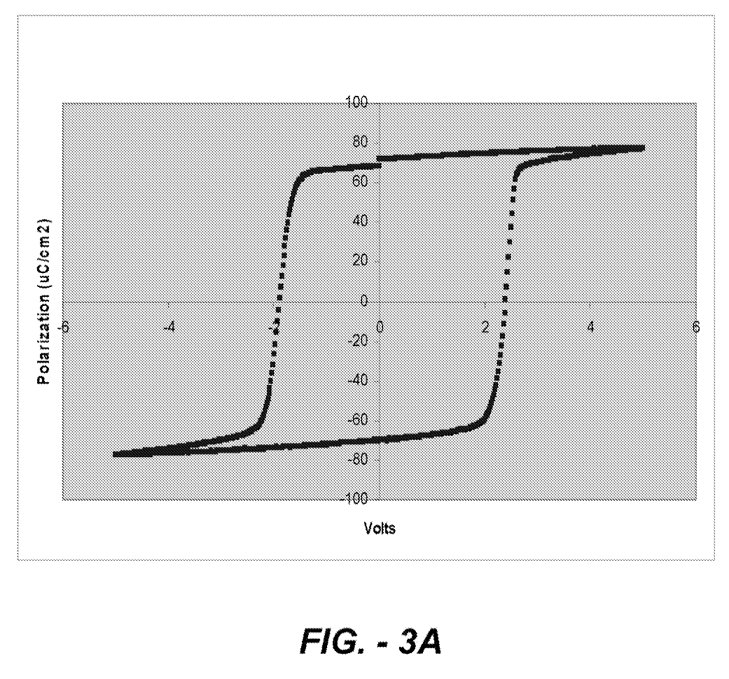

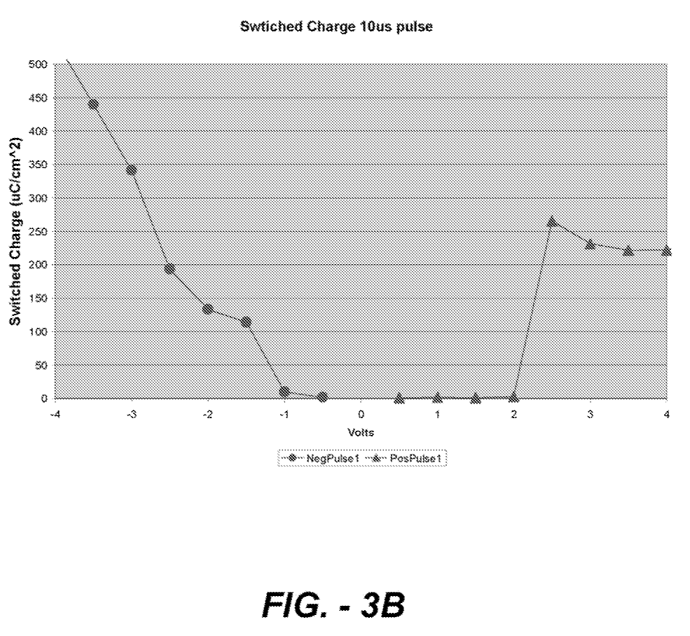

Ferroelectric films have been proposed as promising recording media, with a bit state corresponding to a spontaneous polarization direction of the media, wherein the spontaneous polarization direction is controllable by way of application of an electric field. FIG. 2A is a simplified cross-sectional diagram of an exemplary system for storing information 200 (also referred to herein as a memory device) with which embodiments of media and methods of forming media in accordance with the present invention can be used. Memory devices enabling potentially higher density storage relative to current ferromagnetic and solid state storage technology can include nanometer-scale heads such as contact probe tips, non-contact probe tips, and the like capable of one or both of reading and writing to a media. Memory devices for high density storage can include seek-and-scan probe (SSP) memory devices comprising cantilevers from which probe tips extend for communicating with a media. The cantilevers and probe tips can be implemented in a micro-electromechanical systems (MEMS) device with a plurality of read-write channels working in parallel. Probe tips are hereinafter referred to as tips and can comprise structures that communicate with a media in one or more of contact, near contact, and non-contact mode. A tip need not be a protruding structure. For example, in some embodiments, a tip can comprise a cantilever or a portion of the cantilever.

The memory device 200 comprises a tip substrate 206 arranged substantially parallel to a media 202. Cantilevers 210 extend from the tip substrate 206, and tips 208 extend from respective cantilevers 210 toward the surface of the media 202. A media (also referred to herein as a media stack) can comprise one or more layers of patterned and/or unpatterned ferroelectric films. A ferroelectric recording layer 220 of the media can achieve ultra high bit recording density because the thickness of a 180° domain wall in ferroelectric material is in the range of a few lattices (1-2 nm). The media 202 is associated with a media platform 204 (e.g., a silicon substrate 204). A media substrate 214 comprises the media platform 204 suspended within a frame 212 by a plurality of suspension structures (e.g., flexures, not shown). The media platform 204 can be urged within the frame 212 by way of thermal actuators, piezoelectric actuators, voice coil motors, etc. As shown, the media platform 204 can be urged by electromagnetic motors comprising electrical traces 232 (also referred to herein as coils, although the electrical traces need not contain turns or loops) formed on the media platform and placed in a magnetic field so that controlled movement of the media platform 204 can be achieved when current is applied to the electrical traces 232. A magnetic field is generated outside of the media platform 204 by a first permanent magnet 234 and second permanent magnet 236 arranged so that the permanent magnets 234,236 roughly map the range of movement of the coils 232. The permanent magnets 234,236 can be fixedly connected with a rigid or semi-rigid structure such as a flux plate 235,237 formed from steel, or some other material for acting as a magnetic flux return path and containing magnetic flux. The media substrate 214 can be bonded with the tip substrate 206 and a cap 216 can be bonded with the media substrate 214 to seal the media platform 204 within a cavity 218. Optionally, nitrogen or some other passivation gas can be introduced and sealed in the cavity 218. In alternative embodiments, memory devices can be employed wherein a tip platform is urged relative to the media, or alternative wherein both the tip platform and media can be urged.

FIG. 2B is a partial cross-section showing a distal end of a tip 208 in contact or near contact with the media 202. The tip 208 can perform one or both of reading and writing. The media 202 comprises a ferroelectric recording layer 220 including domains having spontaneous polarization in an “UP” direction 222 and a “DOWN” direction 224. The ferroelectric recording layer 220 can comprise one or more layers of ferroelectric material. The media 202 further comprises a conductive layer 203 above which the recording layer 220 is formed so that the ferroelectric recording layer 220 is disposed between the tip 208 and the conductive layer 203, and typically a substrate 204 (and/or base layer 205, as shown) over which the conductive layer 203 is formed. A voltage source 240 can be used to apply a voltage signal between the tip 208 (or other electrode) and the conductive layer 203.

The tip 208 can be used for writing data to and/or reading data from the ferroelectric media. For example, for writing data, the tip 208 can function as conductive electrode that can be used to apply a voltage potential across the ferroelectric recording layer to selectably set the spontaneous polarization of a domain up or down. For reading data, the tip 208 can be used in various different techniques to determine the polarization of a domain whose polarization had previously been set up or down.

The media 202 (or other similar media including a ferroelectric recording layer 220) may have a built-in bias, which relates to the degree to which there is an asymmetry in effectiveness of an applied positive voltage versus an applied negative voltage. Stated another way, a built-in bias causes a preference for polarization in one of two directions (“UP” and “DOWN”) that are opposite one another and often (but not necessarily) perpendicular to the ferroelectric layer 220 of the media 202. For example, if −4V is required to flip the polarization of a group of domains from “DOWN” to “UP”, but +6V is required to flip the polarization of the same domains from “UP” to “DOWN”, the domains have a negative built-in bias. In contrast, if −6V is required to flip the polarization of a group of domains from “DOWN” to “UP”, but +4V is required to flip the polarization of the same domains from “UP” to “DOWN”, the domains have a positive built-in bias. Finally, if −5V is required to flip the polarization of a group of domains from “DOWN” to “UP”, and +5V is required to flip the polarization of the same domains from “UP” to “DOWN”, the domains can be said to have a zero built-in bias.

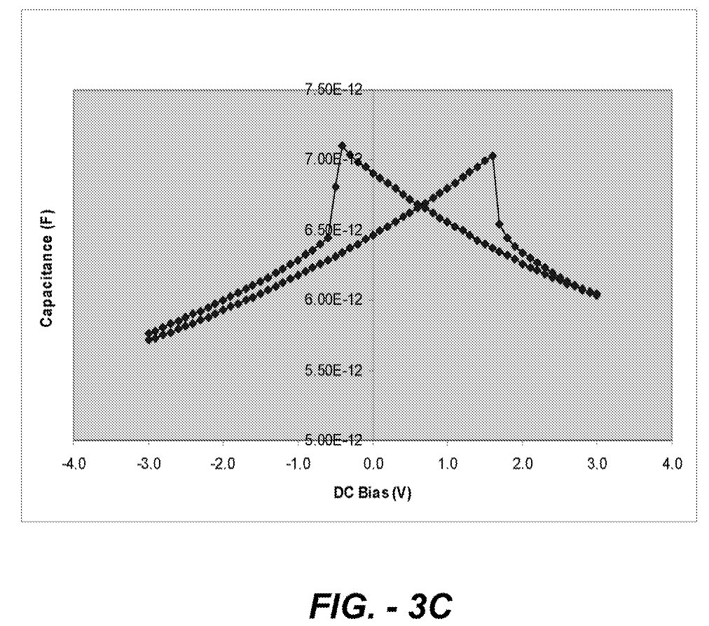

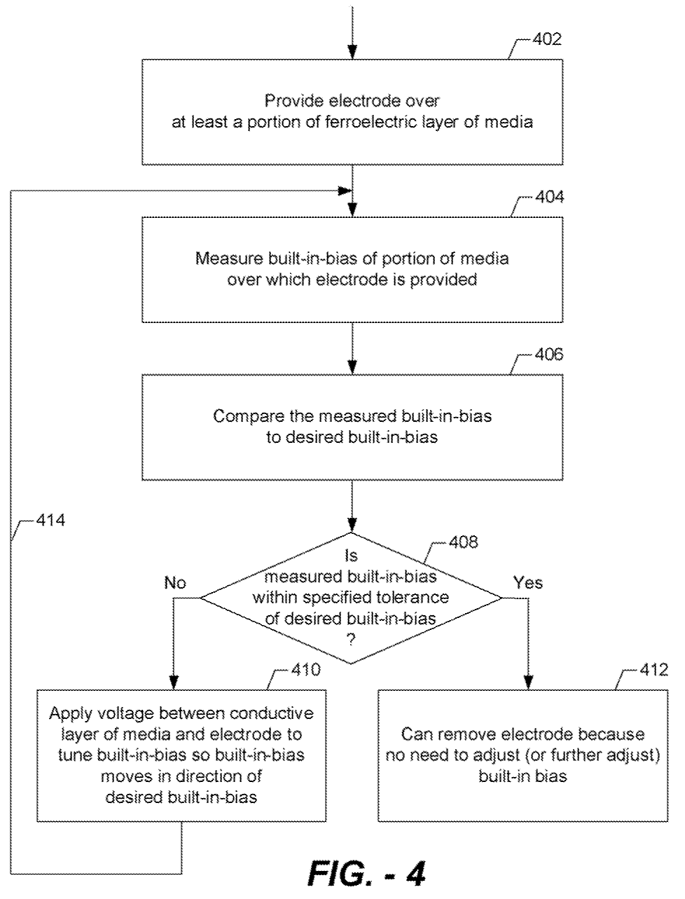

There are various known techniques for measuring and displaying the built-in bias. For example, a hysteresis curve (also known as a hysteresis loop), which is a plot of voltage versus polarization can be produced. An exemplary hysteresis loop is shown in FIG. 3A. If the hysteresis loop of FIG. 3A were centered about the zero origin, this would show a zero built-in bias. However, since the hysteresis loop of FIG. 3A is shifted in the positive direction, it is showing that there is a negative built-in bias. When there is a negative built-in bias, the magnitude of the positive voltage needed to flip the polarization from “UP” to “DOWN” is greater than the magnitude of the negative voltage needed to flip the polarization from “DOWN” to “UP”. Stated another way, a negative built-in bias means that the media favors an “UP” polarization. If the hysteresis loop were instead shifted in the negative direction, it would show that there is a positive built-in bias, meaning that the media favors a “DOWN” polarization. Alternatives measuring techniques can be used to produce a switched charge versus applied voltage pulse plot, e.g., as shown in FIG. 3B, or a capacitance versus voltage plot, e.g., as shown in FIG. 3C. Both FIGS. 3B and 3C show a negative built-in bias. If the plots of FIGS. 3B and 3C were centered and symmetric about 0 volts, they would show a zero built-in bias. These are just a few exemplary techniques that can be used for measuring and displaying a built-in bias, which are not meant to be limiting.

For various reasons, it would be useful to controllably modify the built-in bias of media including a ferroelectric recording layer (e.g., such as media 202). For example, it has been recognized that maintaining stability of the spontaneous polarization of the ferroelectric media may be problematic, potentially limiting use of ferroelectric media in memory devices. In general, a ferroelectric media exhibits spontaneous, uniform, as-grown polarization either in the “UP” or “DOWN” direction. The ferroelectric recording layer 220 can be said to be asymmetrical because the bulk ferroelectric film is substantially uniform in polarization vector. As a result of this asymmetry, domains having an “UP” polarization defined within a portion of a bulk ferroelectric film having an as-grown polarization that is also in the “UP” direction can grow over some period of time and domains having a “DOWN” polarization defined within a portion of the same bulk ferroelectric film can shrink over some period of time (and vice versa in a bulk film having an opposite as-grown polarization). A domain may expand to affect neighboring domains, flipping written bits written to the neighboring domains, or a domain may contract to essentially flip the bit written to the domain from one state to the opposite state. The period of time over which an undesirable amount of domain inflation or deflation occurs may be undesirably short (i.e., failing retention specifications), and the domain (and bit) can be said to be unstable. It is believed that the built-in bias affects such stability of the domains, in that a large built-in bias may result in domains being unstable.

Embodiments of the present invention can be used to adjust the built-in-bias of a media including a conductive layer and a ferroelectric layer (e.g., a PZT layer) above the conductive layer, where for simplicity such media is often simply referred to as ferroelectric media. In some embodiments, the adjustment of the built-in-bias of the ferroelectric media is performed so that a substantially zero built-in bias can be achieved. In other words, in some embodiments, the desired built-in bias is a zero built-in bias. However, this need not be the case if for whatever reason a non-zero built-in bias is desired (e.g., if it is determined that a built-in bias slightly greater or less than zero provides maximum domain stability). Thus, more generally, embodiments of the present invention can be used to move the built-in bias in a direction of a desired built-in bias, and preferably within an acceptable specified threshold of the desired built-in bias.

### Voltage Retuning

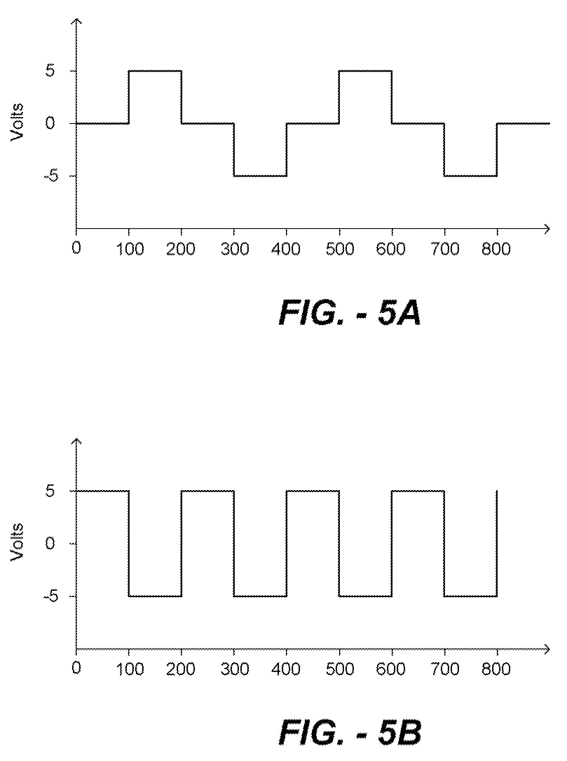

The high level flow diagram of FIG. 4 will now be used to describe specific embodiments of the present invention where a voltage signal is used to adjust the built-in bias of a ferroelectric media that includes a ferroelectric layer above a conductive layer. Referring to FIG. 4, at step 402, an electrode is provided over at least a portion of the ferroelectric layer of the media. The at least a portion of ferroelectric layer of the media, over which the electrode is provided, can be the entire ferroelectric layer, or just a portion thereof.

At step 404, the electrode is used to measure the built-in bias of the portion of the media over which the electrode is provided, wherein the built-in bias causes a preference for polarization in one of two directions that are opposite one another (and likely, but not necessarily perpendicular to the ferroelectric layer). Any known technique for measuring built-in bias can be used, including but not limited to techniques that result in a hysteresis loop (similar to FIG. 3A), a switched charge versus applied voltage pulse plot (similar to FIG. 3B) or a capacitance versus voltage plot (similar to FIG. 3C). The built-in bias can be measured by recording the voltage at which polarization switches from DOWN to UP (and UP to DOWN). This can be done, e.g., by sweeping an applied voltage back and forth across a range known to reverse the polarization, where the reversal is identified by the onset of switched charge (Hysteresis or switched charge) or peak capacitance (switching CV loop).

At step 406, the measured built-in bias is compared to a desired built-in bias. As described above, in an embodiment the desired built-in bias can be a zero built-in bias. In another embodiment, the desired built-in bias can be a non-zero built-in bias, e.g., a slightly negative or slightly positive built-in bias.

At step 408, there is a determination of whether the measured built-in bias is within a specified tolerance (e.g., a predetermined tolerance) of the desired built-in bias. The specified tolerance can be a percentage (e.g., 5%), or a discrete value (e.g., defined in μC/cm²), but is not limited thereto. If the measured built-in bias is not within the specified tolerance of the desired built-in bias, then flow goes to step 410, so that the built-in bias can be adjusted (also referred to as tuned or retuned). If the measured built-in bias is within the specified tolerance of the desired built-in bias, then flow goes to step 412, and the electrode (provided at step 402) can be removed, and the adjusting of the built-in bias (of the portion of the media over which the electrode is provided at step 402) can end, as indicated at 414. In other words, in accordance with an embodiment, step 410 only occurs if the built-in bias measured at step 404 is not within a specified tolerance of the desired built-in bias.

At step 410, a voltage signal is applied between the conductive layer of the media and the electrode (provided over at least a portion of the ferroelectric layer at step 402) to thereby tune the built-in bias so that the built-in bias moves in a direction of (i.e., closer to) the desired built-in bias. The built-in bias can be in the up direction, or the down direction, as was described above. In accordance with an embodiment, the voltage signal applied at step 410 toggles between a positive voltage level and a negative voltage level, where the positive voltage level is sufficient to change the polarization of the ferroelectric layer of the media from an up direction polarization to a down direction polarization, and the negative voltage level is sufficient to change the polarization of the ferroelectric layer of the media from a down direction polarization to an up direction polarization. In other words, in an embodiment, the voltage signal applied at step 410 causes repeated switching (i.e., flipping) of the polarization of the portion of the ferroelectric layer of the media over which the electrode at step 402 is provided, in order to reduce the built-in bias. In an embodiment, at least 10 cycles of the signal are applied at step 410, and preferably at least 1000 cycles. Thus, if the signal has a 400 milliseconds (ms) duty cycle, the signal can be applied for at least 4 seconds, and preferably for at least 400 seconds. If the signal has a 200 ms duty cycle, the signal can be applied for at least 2 seconds, and preferably for at least 200 seconds.

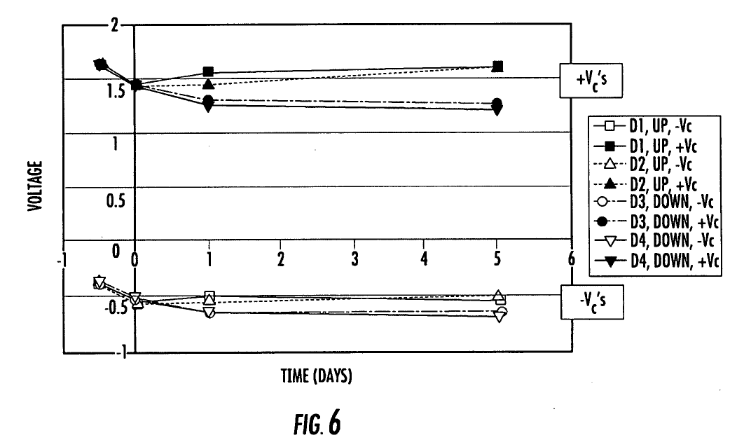

Exemplary waveforms of the voltage signal applied at step 410 are illustrated in FIGS. 5A and 5B. Referring to FIG. 5A, the exemplary voltage signal is shown as having a duty cycle of 400 ms, including a 100 ms portion at 0 Volts (V), followed by a 100 ms portion at +5 V, followed by a 100 ms portion at 0 V, followed by a 100 ms portion at −5 V. Accordingly, the voltage signal of FIG. 5A returns to zero for a period of time before changing from a positive voltage level to a negative voltage level, and before changing from the negative voltage level to the positive voltage level. Referring now to FIG. 5B, the exemplary voltage signal is shown as having a duty cycle of 200 ms, including a 100 ms portion at +5V, followed by a 100 ms portion at −5V. Accordingly, the voltage signal of FIG. 5B does not return to zero for a period of time before changing from a positive voltage level to a negative voltage level, and before changing from the negative voltage level to the positive voltage level. The exemplary voltage signals shown in FIGS. 5A and 5B are symmetrical, however that need not be the case. Further, the voltage signals shown in FIGS. 5A and 5B toggle between negative and positive voltages having the same magnitude, however that need not be the case. In other words, the voltage signals need not be symmetric, and the negative and positive voltage levels need not have the same magnitudes. However, the magnitudes of the positive and negative voltage levels should be sufficient to cause the flipping of the polarization of the ferroelectric layer of the media, since it is the repeated flipping of the polarization that is believed to reduce the built-in bias.

In accordance with an embodiment, steps 404, 406, 408 and 410 can be repeated until the measured built-in bias is within the specified tolerance of the desired built-in bias, as specified by the arrow 414 in the flow diagram of FIG. 4. In accordance with an embodiment, each time the built-in bias is measured at step 404, the voltage signal (applied at step 410) is unapplied so that the voltage signal does not affect measurement of the built-in bias. When the measured built-in bias is within the specified tolerance of the desired built-in bias (i.e., when flow is from step 408 to step 412), the electrode (provided at step 402) can be removed, as indicated at step 412.

In accordance with an embodiment, the electrode can be provided over at least a portion of the ferroelectric layer at step 402 by moving the electrode and/or the media relative to one another. For example, referring back to FIGS. 2A and 2B, the electrode can be one or more tip(s) 208, which can be moved relative to the media 202 and/or the media 202 can be moved relative to the tip(s) 208.

In accordance with an embodiment, at step 402, the electrode is provided over the at least a portion of the ferroelectric layer by depositing the electrode over the at least a portion of the ferroelectric layer. Thereafter, at step 412, the electrode can be removed, e.g., by etching, delaminating, or dissolving the electrode.

In an embodiment, the electrode, provided over at least a portion of the ferroelectric layer at step 402, can comprise a conductive metal. Alternatively, the electrode can comprise a conductive liquid. If the electrode is a conductive liquid, the conductive liquid electrode can be contained, e.g., using an o-ring, or the like.

In accordance with an embodiment, the steps described with reference to FIG. 4 are performed before user data is written to the portion of the media over which the electrode is provided at step 402. In other words, the method described with reference to FIG. 4 can be used to controllably adjust the built-in bias of media prior to the media being incorporated into a device or system (e.g., memory device 200) and used as a means for storing user data for such a device or system.

At step 402 the electrode can be provided over an entire ferroelectric layer of a media, or just a portion thereof. When provided over the entire ferroelectric layer, the built-in bias of the entire media can be adjusted at the same time. When provided over just a portion of the ferroelectric layer, the built-in bias of only a portion of the media is adjusted at one time. Thereafter the same electrode can be moved relative to the media so it is over a different portion of the ferroelectric layer (or a different electrode can be used), so that the built-in bias of another portion of the media is adjusted. In this manner, the built-in bias of a media can be adjusted a portion at a time, which can be useful if different portions of the same media have different built-in biases.

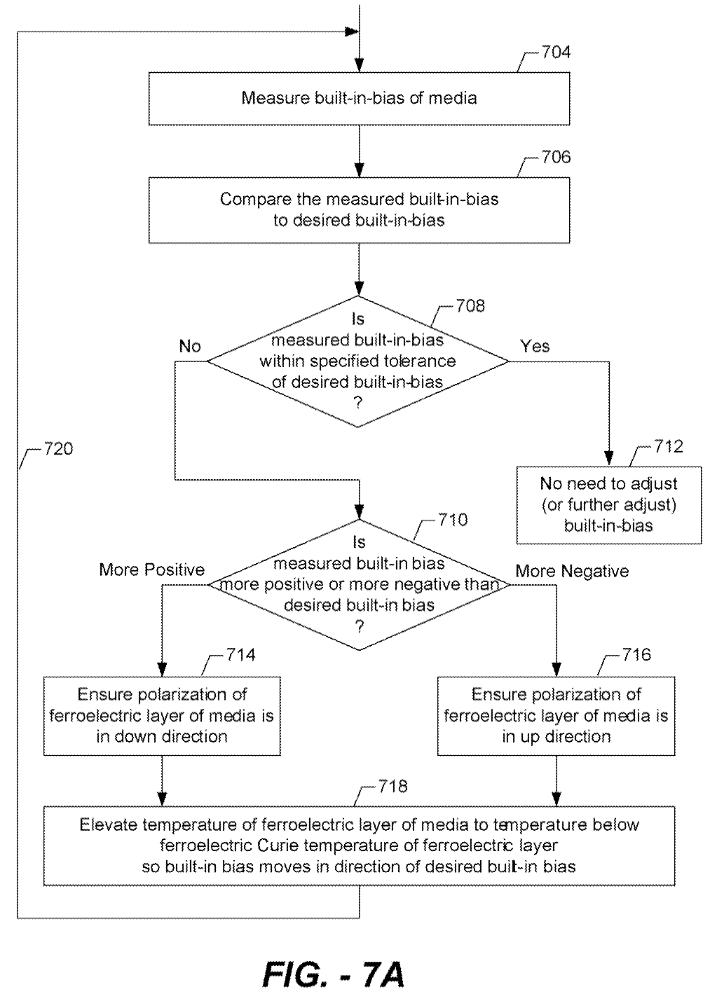

The embodiments of the present invention described with reference to FIG. 4 can be referred to as voltage retuning of built-in-bias. FIG. 6 is a graph that shows how the built-in biases of four domains (labeled D1, D2, D3 and D4) were adjusted by voltage retuning, using a voltage signal similar to the one shown in FIG. 5A, which was applied for 1000 cycles. In the graph of FIG. 6, the +Vc voltages are those voltages required to change the polarization of a domain from “UP” to “DOWN”, and the −-Vc voltages are those voltages required to change the polarization of a domain from “DOWN” to “UP”. The data points to the left of the zero on the vertical time axis are what the polarization switching voltages (−Vc and +Vc) were prior to the voltage retuning procedure. The data points at 0 days were what the switching voltages were immediately after the voltage retuning of the built-in bias, i.e., zero days after the voltage retuning of the built-in bias. From that point on (days 1 to 6) some domains were set UP and some were set DOWN, and then their switching voltages were tracked over time. As can be appreciated from the graph, immediately after the voltage retuning of the built-in bias there was a large shift in −Vc and +Vc. Days after the voltage retuning of the built-in bias, −Vc continued to improve for domains set “DOWN”, but degraded slightly for domains set “UP”. Days after the voltage retuning of the built-in bias, +Vc approached the initial state for domains set “UP”, and continued to approach a zero built-in bias for the domains set “DOWN”.

### Thermal Retuning

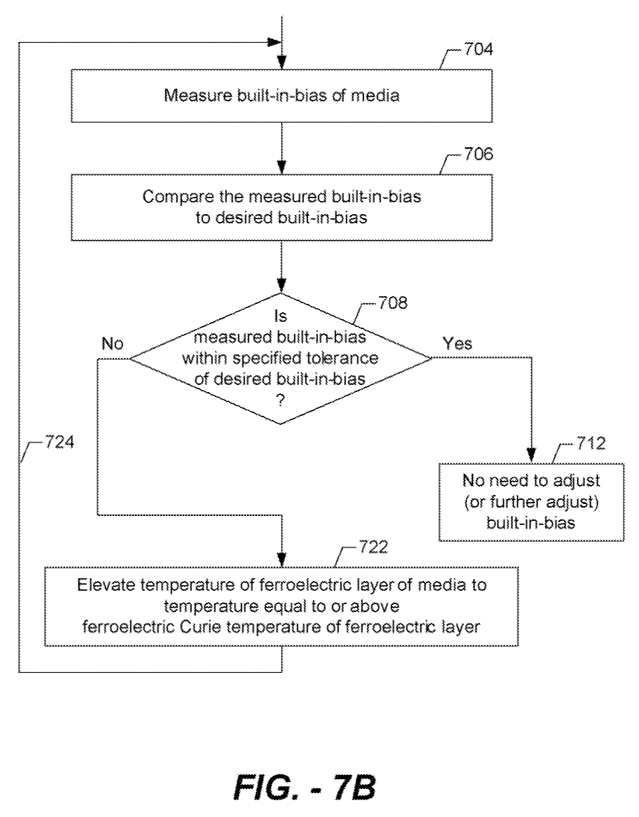

The high level flow diagram of FIG. 7A will now be used to described specific embodiments of the present invention for adjusting the built-in bias of media by elevating the temperature of the ferroelectric layer of the media to a temperature below the ferroelectric Curie temperature of the ferroelectric layer. Thereafter, FIG. 7B will be used to describe embodiments for adjusting the built-in bias of media by elevating the temperature of the ferroelectric layer of the media to a temperature equal to or above the ferroelectric Curie temperature of the ferroelectric layer. Both embodiments will be collectively referred to hereafter as thermal retuning of built-in bias embodiments. The embodiments of FIG. 7A can be specifically referred to as thermal retuning embodiments where the ferroelectric Curie temperature is not reached. The embodiments of FIG. 7B can be specifically referred to as thermal retuning embodiments where the ferroelectric Curie temperature is reached or exceeded.

Referring to FIG. 7A, at step 704, the built-in bias of at least a portion of the ferroelectric layer of the media is measured, wherein the built-in bias causes a preference for polarization in one of two directions that are opposite one another (and likely, but not necessarily perpendicular to the ferroelectric layer). Any known technique for measuring built-in bias can be used, including but not limited to techniques that result in a hysteresis loop (similar to FIG. 3A), a switched charge versus applied voltage pulse plot (similar to FIG. 3B) or a capacitance versus voltage plot (similar to FIG. 3C). Step 704 is similar to step 404 discussed above, and thus need not be described in additional detail.

At step 706, the measured built-in bias is compared to a desired built-in bias. As described above, in an embodiment the desired built-in bias can be a zero built-in bias. In another embodiment, the desired built-in bias can be a non-zero built-in bias.

At step 708, there is a determination of whether the measured built-in bias is within a specified tolerance (e.g., a predetermined tolerance) of the desired built-in bias.

Step 708 is similar to step 408 described above, and thus need not be described in additional detail.

If the measured built-in bias is not within the specified tolerance of the desired built-in bias, then flow goes to step 710, so that the built-in bias can be adjusted (also referred to as tuned or retuned). If the measured built-in bias is within the specified tolerance of the desired built-in bias, then flow goes to step 712, and the adjusting of the built-in bias need not be performed. In other words, in accordance with an embodiment, step 710 only occurs if the built-in bias measured at step 704 is not within a specified tolerance of the desired built-in bias.

In embodiments where the ferroelectric Curie temperature is not reached, the built-in bias will move in the direction of the polarization of the ferroelectric layer. In other words, if the ferroelectric layer has an “UP” polarization while the media is heated to a temperature below the ferroelectric Curie temperature, then the built-in bias will move in the negative direction. Conversely, if the ferroelectric layer has a “DOWN” polarization while the media is heated to a temperature below the ferroelectric Curie temperature, then the built-in bias will move in the positive direction. In this manner, these embodiments provide for control over the direction in which the built-in bias can be moved, as opposed to some embodiments (discussed below) which are only capable of reducing the magnitude of the built-in bias. Accordingly, if the measured built-in bias is more negative than the desired built-in bias (as determined at step 710), it should be ensured that the polarization of the portion of the media (for which the built-in bias is being adjusted) is in the down direction (as indicated at step 714). Conversely, if the measured built-in bias is more positive than the desired built-in bias (as determined at step 710), it should be ensured that the polarization of the at least a portion of the media is the up direction (as indicated at step 716). Thus, if the polarization is already in the appropriate direction, the polarization need not be flipped at steps 714 and/or 716 (e.g., from the up direction to the down direction, or vice versa). However, if the polarization is in the wrong direction, then the polarization should be appropriately flipped at steps 714 and/or 716, preferably prior to the elevating of the temperature (or alternatively, during the elevating of the temperature, or after the elevating of the temperature).

At step 718, the temperature of at least a portion of the ferroelectric layer of the media is elevated to a temperature below the ferroelectric Curie temperature of the ferroelectric layer, so that the built-in bias moves in a direction of the desired built-in bias. The ferroelectric Curie temperature for ferroelectric materials is the temperature above which it completely loses its characteristic spontaneous polarization. At temperatures below the ferroelectric Curie temperature, local dipole moments align to produce a spontaneous polarization in ferroelectric materials. As the temperature is increased towards the ferroelectric Curie temperature, the dipole within each domain decreases. If the temperature were to reach or exceed the ferroelectric Curie temperature, the material would be purely paraelectric and there would be no dipole moment or spontaneous polarization.

Preferably, at step 718 the ferroelectric layer of the media (or portion thereof) is heated to at least 200 degrees Celsius. In other words, the ferroelectric layer of the media is elevated to a temperature between 200 degrees Celsius and the ferroelectric Curie temperature of the ferroelectric layer. Alternatively, the media can be heated to a temperature less than 200 degrees Celsius, e.g., to a temperature of at least 130 degrees Celsius, so long as the temperature is sufficient to adjust the built-in bias. The temperature of the ferroelectric layer of the media can be raised by directly applying heat to the ferroelectric layer or the conductive layer, or both (and/or to a substrate, if the conductive layer is formed on a separate substrate). For example, a heated chuck or other heated element can be used. Alternatively, or additionally, the temperature within a chamber (within which the media is located or otherwise placed) can be elevated to the desired temperature. Alternative techniques for elevating the temperature of the ferroelectric layer of the media are also possible, and within the scope of the present invention.

In the thermal retuning embodiments, elevating the temperature of the ferroelectric layer of the media will likely also result in the temperature of various other layers of the media also being elevated, since it would be difficult to only heat one layer without heating other layer(s). This is fine so long as the other layer(s) are not elevated to a temperature that causes such layer(s) to melt or otherwise degrade.

In accordance with an embodiment, steps 704, 706, 708 and 710 can be repeated until the measured built-in bias is within the specified tolerance of the desired built-in bias, as specified by the arrow 720 in the flow diagram of FIG. 7. In accordance with an embodiment, each time the built-in bias is measured at step 704, the heat (applied at step 718) is removed and the temperature of the ferroelectric layer is returned to it's normal temperature (e.g., room temperature) so that the temperature does not affect measurement of the built-in bias. When the measured built-in bias is within the specified tolerance of the desired built-in bias (i.e., when flow is from step 708 to step 712), the adjustment of the built-in bias (using the thermal retuning embodiments where the ferroelectric Curie temperature is not reached) is finished.

At step 722 an entire ferroelectric layer of a media can be heated, or just a portion thereof. When elevating the temperature of the entire ferroelectric layer, the built-in bias of the entire media can be adjusted at the same time. When heating just a portion of the ferroelectric layer (e.g., using a local hot probe or chuck), the built-in bias of only a portion of the media is adjusted at one time. Thereafter the same heating element can be moved relative to the media so it can be used to elevate the temperature of a different portion of the ferroelectric layer (or a different heating element can be used), so that the built-in bias of another portion of the media is adjusted. In this manner, the built-in bias of a media can be adjusted a portion at a time, which can be useful if different portions of the same media have different built-in biases.

The entire ferroelectric media can be heated at the same time, e.g., using a sufficiently large heating element (e.g., heated chuck), by forcing heated air into the chamber where the media is located, or by moving the media into a heated chamber, but is not limited thereto. If various portions of the same media have the same built-in biases (which can be determined by measuring built-in biases a portion at a time at step 704), the built-in biases of the different portions can be adjusted simultaneously in the same manner. If different portions of the same media have different built-in biases (which can be determined by measuring built-in biases a portion at a time at step 704), the built-in biases of the different portions can adjusted simultaneously in different directions as follows.

Assume a first portion of the media has a built-in bias that is more negative than the desired built-in bias, and a second portion of the media has a built-in bias that is more positive than desired. The built-in biases of both the first portion and the second portion can be appropriately adjusted at the same time by ensuring that the polarization of the first portion of the media is in the down direction, and ensuring that the polarization of the second portion of the media is the up direction, prior to the elevating of the temperature of the ferroelectric layer to the temperature (e.g., 250 degrees Celsius) that is below the ferroelectric Curie temperature.

For another example, assume both a first portion and a second portion of the media have a built-in biases that are more negative than the desired built-in bias, but the first portion needs more adjustment than the second portion (e.g., the first portion is much more negative than desired, but the second portion is only a little more negative than desired). The built-in biases of both the first portion and the second portion can be adjusted at the same time by causing that the polarization of the first portion of the media to be in the down direction the entire time the temperature of the ferroelectric layer is elevated to the temperature (e.g., 250 Degrees Celsius) that is below the ferroelectric Curie temperature, but causing that the polarization of the second portion of the media to be in the down direction only a percentage of the time (e.g., 70% of the time) the temperature of the ferroelectric layer is elevated to the temperature (e.g., 250 Degrees Celsius) that is below the ferroelectric Curie temperature, and causing that the polarization of the second portion of the media to be in the up direction the remaining percentage of the time (e.g., 30% of the time) that the temperature of the ferroelectric layer is elevated to the temperature (e.g., 250 Degrees Celsius) that is below the ferroelectric Curie temperature. Such embodiments provide for both global and localized simultaneous adjusting of the built-in biases.

FIG. 7B will now be used to describe thermal retuning embodiments where the ferroelectric Curie temperature is reached or exceeded. Referring to FIG. 7B, steps 704, 706 and 708 are the same as in FIG. 7A, and thus need not be described again. If the determination at step 708 is that the measured built-in bias is not within the specified tolerance of the desired built-in bias, then flow goes to step 722, so that the built-in bias can be adjusted (also referred to as tuned or retuned). If the measured built-in bias is within the specified tolerance of the desired built-in bias, then flow goes to step 712, and the built-in bias need not be adjusted (or further adjusted). In other words, in accordance with an embodiment, step 710 only occurs if the built-in bias measured at step 706 is not within a specified tolerance of the desired built-in bias.

At step 722, the temperature of at least a portion of the ferroelectric layer of the media is elevated to a temperature equal to or above the ferroelectric Curie temperature of the ferroelectric layer, so that the built-in bias moves in a direction of (i.e., towards) the desired built-in bias. As mentioned above, the ferroelectric Curie temperature for ferroelectric material is the temperature above which the ferroelectric material loses its spontaneous polarization. When the temperature exceeds the ferroelectric Curie temperature, the material becomes purely paraelectric and there is no spontaneous polarization.

In accordance with an embodiment, the ferroelectric layer (or portion thereof) of the media is maintained at the elevated temperature above its ferroelectric Curie temperature for a length of time ranging between about 1 minute and about 100 minutes, and in specific embodiments, for at least 10 minutes. Such maintenance of the temperature above the ferroelectric Curie temperature for at least some length of time is believed to provide the reduction of the built-in bias.

While the ferroelectric material is equal to or exceeds its ferroelectric Curie temperature, there is no spontaneous polarization and it is believed that the built-in bias dissipates as the species responsible for it are allowed to diffuse within the material. However, if the ferroelectric material is allowed to cool on its own (i.e., in a relatively slow manner, e.g., of less than 1 degree per second), a significant amount of built-in bias may return during the cooling. To reduce this effect, the cooling of the ferroelectric layer (or portion thereof) of the media from the temperature above its ferroelectric Curie temperature to at least 50 degrees Celsius is performed at a rate of at least 10 degrees per second or faster. In specific embodiments, the cooling is from the temperature above the ferroelectric Curie temperature to at least 50 degrees Celsius in 10 seconds or less. In some embodiments, the cooling is from the temperature above the ferroelectric Curie temperature to at least 25 degrees Celsius in 5 seconds or less. Such rapid cooling can be achieved, e.g., by contacting the media (or portion thereof) with a cooled plate or chuck, by placing the media in a cooling chamber, or by forcing cooled air into a same chamber where the heating occurred, but is not limited thereto.

### Voltage and Thermal Retuning

The various embodiments of the present invention described above can be combined. For example, while the temperature of the ferroelectric layer of the media (or portion thereof) is elevated to a temperature below the ferroelectric Curie temperature of the ferroelectric layer, a voltage signal similar to the ones shown in FIGS. 5A and 5B can be applied between the conductive layer of the media and an electrode over provided over the ferroelectric layer (or portion thereof). In other words, the voltage retuning and thermal retuning embodiments can be performed simultaneously. Alternatively, the voltage retuning and thermal retuning embodiments can be performed serially, one after the other. For example, one type of retuning can be used for course retuning, and the other can be used for fine retuning.

Embodiments of the present invention are directed to methods for adjusting the built-in bias of media, as well as the resulting media. Additionally, embodiments of the present invention are also directed to systems/devices for storing information (such as storage device 200 described with reference to FIGS. 2A and 2B) that include such media.

The foregoing description of embodiments of the present invention have been presented for purposes of illustration and description. It is not intended to be exhaustive or to limit the invention to the precise forms disclosed. Many modifications and variations will be apparent to practitioners skilled in this art. The embodiments were chosen and described in order to best explain the principles of the invention and its practical application, thereby enabling others skilled in the art to understand the invention for various embodiments and with various modifications as are suited to the particular use contemplated. It is intended that the scope of the invention be defined by the following claims and their equivalents.

1. A method for adjusting a built-in bias of a media including a conductive layer and a ferroelectric layer above the conductive layer, the method comprising:
(a) providing an electrode over at least a portion of the ferroelectric layer of the media;
(b) using the electrode to measure the built-in bias of the portion of the media over which the electrode is provided, wherein the built-in bias causes a preference for polarization in one of two directions that are opposite one another;
(c) comparing the measured built-in bias to a desired built-in bias; and
(d) applying a voltage signal between the conductive layer of the media and the electrode to thereby tune the built-in bias so that the built-in bias moves in a direction of the desired built-in bias.

2. The method of claim 1, wherein:
the two directions comprise an up direction and a down direction; and
the voltage signal applied at step (d) toggles between a positive voltage level and a negative voltage level, the positive voltage level being sufficient to change the polarization of the ferroelectric layer of the media from an up direction polarization to a down direction polarization, and the negative voltage level being sufficient to change the polarization of the ferroelectric layer of the media from a down direction polarization to an up direction polarization.

3. The method of claim 1, wherein the voltage signal applied at step (d) causes repeated switching of the polarization of the portion of the ferroelectric layer of the media over which the electrode is provided.

4. The method of claim 1, wherein step (d) comprises only applying the voltage signal if the built-in bias measured at step (b) is not within a specified tolerance of the desired built-in bias.

5. The method of claim 4, wherein steps (b), (c) and (d) are repeated until the measured built-in bias is within the specified tolerance of the desired built-in bias, and wherein each time the built-in bias is measured at step (b) the voltage signal is unapplied so that the voltage signal does not affect measurement of the built-in bias.

6. The method of claim 5, further comprising:
(e) removing the electrode after the built-in bias is within the specified tolerance of the desired built-in bias.

7-15. (canceled)

16. A method for adjusting the built-in bias of media including a conductive layer and a ferroelectric layer above the conductive layer, the method comprising:
(a) providing an electrode over a portion of the ferroelectric layer of the media; and
(b) applying a voltage signal between the conductive layer of the media and the electrode to thereby repeatedly switch a polarization of the portion ferroelectric layer of the media over which the electrode is provided, in order to thereby reduce a magnitude of the built-in bias;
wherein steps (a) and (b) are performed before user data is written to the portion of the media over which the electrode is provided.

17. The method of claim 16, wherein step (b) comprises repeatedly switching between an up polarization and a down polarization.

18-20. (canceled)

21. A method for adjusting a built-in bias of a media including a conductive layer and a ferroelectric layer above the conductive layer, the method comprising:
(a) measuring the built-in bias of at least a portion of the media, wherein the built-in bias causes a preference for polarization in one of two directions that are opposite one another;
(b) comparing the measured built-in bias to a desired built-in bias; and
(c) elevating the temperature of the at least a portion of the ferroelectric layer of the media to thereby tune the built-in bias so that the built-in bias moves in a direction of the desired built-in bias.

22. The method of claim 21, wherein step (c) comprises elevating the temperature of the at least a portion of the ferroelectric layer of the media to a temperature below the ferroelectric Curie temperature of the ferroelectric layer.

23. The method of claim 22, wherein the two directions comprise an up direction and a down direction, and further comprising, before or during step (c):
if the measured built-in bias is more negative than the desired built-in bias, ensuring that the polarization of the at least a portion of the ferroelectric layer of the media is in the down direction; and
if the measured built-in bias is more positive than the desired built-in bias, ensuring that the polarization of the at least a portion of the ferroelectric layer of the media is the up direction.

24. The method of claim 22, wherein step (c) comprises elevating the temperature of the at least a portion of the ferroelectric layer of the media to at least 200 degrees Celsius.

25. The method of claim 21, wherein step (c) comprises elevating the temperature of the at least a portion of the ferroelectric layer of the media to a temperature equal to or above the ferroelectric Curie temperature of the ferroelectric layer.

26. The method of claim 25, further comprising:
(d) cooling the at least a portion of the ferroelectric layer of the media from the temperature equal to or above the ferroelectric Curie temperature to at least 50 degrees Celsius at a rate of at least 10 degrees per second or faster.

27. The method of claim 21, wherein the at least a portion of the ferroelectric layer of the media is maintained at the elevated temperature for a length of time ranging between about 1 minute and about 100 minutes.

28. The method of claim 21, wherein the at least a portion of the ferroelectric layer of the media is maintained at the elevated temperature for at least about 10 minutes.

29. A method for adjusting a built-in bias of a media including a conductive layer and a ferroelectric layer above the conductive layer, the method comprising:
(a) ensuring a polarization of at least a portion of the ferroelectric layer of the media to be in a same direction in which the built-in bias is to be moved; and
(b) elevating the temperature of the at least a portion of the ferroelectric layer of the media to a temperature that is below the ferroelectric Curie temperature of the media.

30. The method of claim 29, wherein the built-in bias causes a preference for an up polarization or a down polarization, and wherein step (a) comprises:
if the built-in bias is more negative than a desired built-in bias, ensuring that the polarization of the at least a portion of the ferroelectric layer of the media is in the down direction; and
if the built-in bias is more positive than the desired built-in bias, ensuring that the polarization of the at least a portion of the ferroelectric layer of the media is the up direction.

31-40. (canceled)
